(19) United States
(12) Patent Application Publication
(10) Pub. No.: US 2006/0263623 A1
(43) Pub. Date: Nov. 23, 2006

(54) Aluminum alloy plate member having hem portion

(76) Inventor: Hidetoshi Uchida, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 10/570,614

(22) PCT Filed: Sep. 8, 2003
(86) PCT No.: PCT/JP03/11449

§ 371 Date: Mar. 3, 2006

(51) Int. Cl. B60R 13/08

(52) U.S. Cl. 428/595

(57) ABSTRACT

An aluminum alloy sheet member 1 having a hem region 25 and comprising an outer component 2 which is made of an aluminum alloy sheet and an inner component 3 which is made of an aluminum alloy sheet and attached to the outer component 2. The aluminum alloy sheet member has a hem end portion 255 at an end of the hem region 25 whose outer bending radius R satisfies R=1.0T-1.2T with respect to a sheet thickness T of the outer component 2. The aluminum alloy sheet member preferably includes an appressed portion at the hem end portion 255 formed by bending the outer component 2 by 180° in a contacting manner.

### TECHNICAL FIELD

The present invention relates to an aluminum alloy sheet member having a hem region.

### BACKGROUND ART

Steel sheet members comprised by mounting inner components to outer components made of steel sheets have been conventionally used for application to outer panels or the like of the vehicles such as automobiles.

As illustrated in FIG. 8, the steel sheet member 8 is comprised by folding back the end of an outer component 81 inward by approximately 180 degrees to form a hem region 85 and pinching and holding the inner component 83 in the hem region 85. The shape of the outer component 81 at the hem region 85 was a substantially U-shaped form, so-called flat hem style. By arranging the hem region 85 as a flat hem in this manner, it is possible to exhibit a superior external surface appearance that is suitable for use in outer panels of vehicles or the like.

An aluminum alloy has attracted the notice to as a material alternative to steel. An aluminum alloy exhibits properties of light weight and corrosion resistance, and since application thereof to outer panels of vehicles or the like results in improvements in fuel consumption and weight saving of the vehicle body, it is being widely turned into actual utilization.

However, when employing an outer component that is comprised of such an aluminum alloy sheet alternative to a steel sheet, it is necessary to employ an aluminum alloy sheet having a thickness that is approximately 1.5 times as large as that of a steel sheet in the view of rigidity. Accordingly, when the above flat hem is formed by using an outer component 81 comprised by the above aluminum alloy sheet, the thickness of the hem region 85 is increased and an outer bending radius r of a hem end portion 88 is increased. This has accordingly led to the problem that the sharpness of the external appearance is harmed.

### DISCLOSURE OF THE INVENTION

The present invention has been made in view of the above conventional problems and an object of the present invention is to provide an aluminum alloy sheet member having a superior external appearance at its hem region comparable to the external appearance at a hem region made of a steel sheet.

The present invention is an aluminum alloy sheet member having a hem region and comprising an outer component which is made of an aluminum alloy sheet and an inner component which is made of an aluminum alloy sheet and attached to the outer component,

wherein the aluminum alloy sheet member has a hem end portion at the end of the hem region whose outer bending radius R satisfies R=1.0T-1.2T with respect to the sheet thickness T of the outer component.

The aluminum alloy sheet member of the present invention has a hem end portion whose outer bending radius R satisfies R=1.0T-1.2T with respect to the sheet thickness T of the outer component.

With this arrangement, the outer bending radius R of the hem end portion is smaller than that of the above described conventional flat hem so that the external appearance at the hem region is sharp and thus superior. Therefore, it can be suitably applied to products which were conventionally made mainly of steel sheets such as outer panels of body sheets, hoods, doors or trunk lids of vehicles or the like.

In this manner, the present invention can provide an aluminum alloy sheet member having a superior external appearance at its hem region comparable to the external appearance at a hem region made of a steel sheet.

By the way, the outer bending radius R is a radius of a circle that includes an outer edge of the hem end portion as a part of its circumference.

### BRIEF DESCRIPTION OF THE DRAWINGS

FIG. 1 is a perspective view illustrating an entire of an aluminum alloy sheet member according to Embodiment 1.

FIG. 2 is an enlarged explanatory view illustrating a hem region of the aluminum alloy sheet member according to Embodiment 1.

FIG. 3 is an explanatory view illustrating a down-flange step according to Embodiment 1.

FIG. 4 is an explanatory view illustrating a pre-hem step according to Embodiment 1.

FIG. 5 is an explanatory view illustrating a method of forming the hem region of the aluminum alloy sheet member according to Embodiment 1.

FIG. 6 is an enlarged explanatory view illustrating a hem region of an aluminum alloy sheet member according to Embodiment 2.

FIG. 7 is an explanatory view illustrating a method of forming the hem region of the aluminum alloy sheet member according to Embodiment 2.

FIG. 8 is an explanatory view illustrating a shape of a flat hem according to the prior art.

### BEST MODE FOR CARRYING OUT THE INVENTION

In the present invention, it is preferable to include an appressed portion at the hem end portion formed by bending the outer component by 180° in a contacting manner.

In this case, the outer bending radius R at the hem region becomes substantially R=1.0T with respect to the sheet thickness T of the outer component so that the external appearance at the hem region can be even sharper and thus superior.

Also, it is preferable to include no appressed portion at the hem end portion but a space which is surrounded by the outer component and the inner component and whose shape is a substantially triangular shape having a corner formed between the outer component as one of the peaks thereof.

In this case, the external appearance at the hem region becomes even sharper so as to further improve the performance of design.

Also, it is preferable that the material of the outer component is a 6000-series aluminum alloy.

In this case, it is possible to reduce the occurrence of roughing or cracks in peripheries of the surface of the hem end portion by taking advantage of a superior bending workability of the 6000-series aluminum alloy.

It is also possible to obtain the member suitable for use as body sheets of vehicles or the like by taking advantage of the superior strength properties of the 6000-series aluminum alloy.

### Embodiment 1

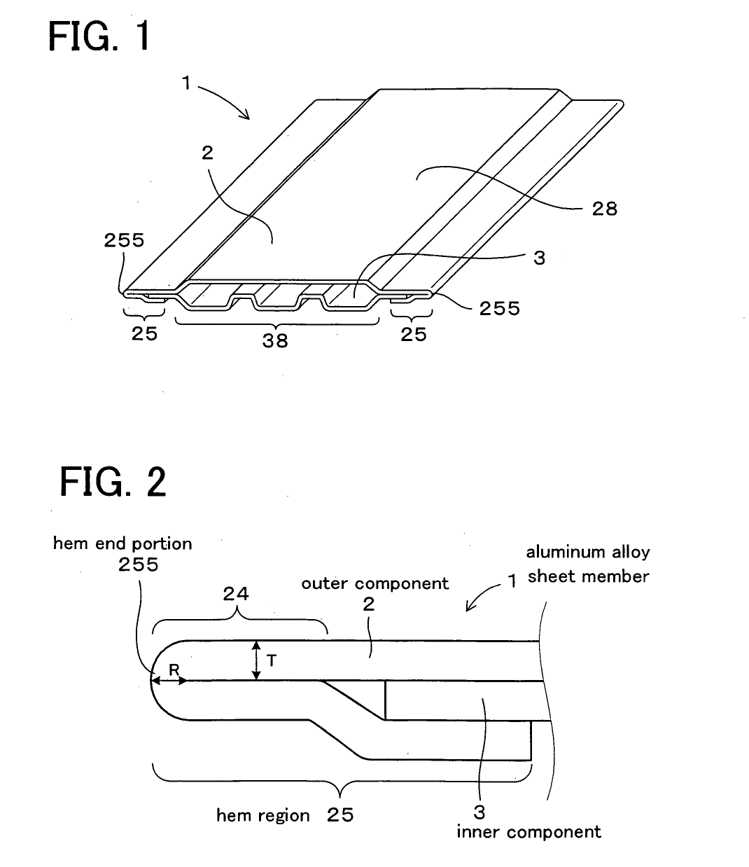

Now, a body sheet of a vehicle as the aluminum alloy sheet member according to an embodiment of the present invention will be explained by using FIGS. 1 to 5.

As illustrated in FIGS. 1 and 2, an aluminum alloy sheet member 1 of the present embodiment is an aluminum alloy sheet member 1 having a hem region 25 and comprising an outer component 2 which is made of an aluminum alloy sheet and an inner component 3 which is made of an aluminum alloy sheet and which is attached to the outer component 2.

At the end of the hem portion 25, the aluminum alloy sheet member 1 has a hem end portion 255 whose outer bending radius R satisfies R=1.0T-1.2T with respect to the sheet thickness T of the outer component 2.

A method for manufacturing the aluminum alloy sheet member will now be explained by using FIGS. 1 to 5.

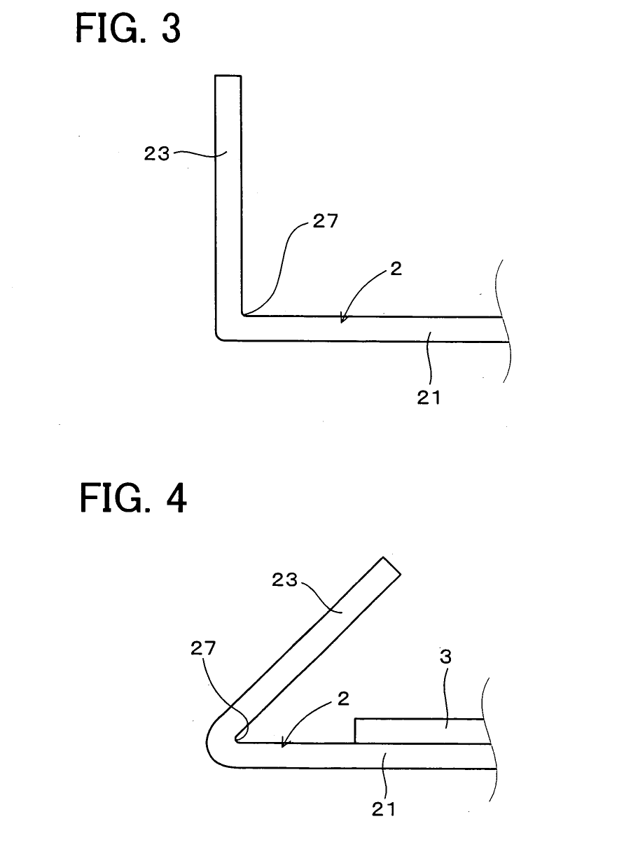

In the method for manufacturing the aluminum alloy sheet member 1 of the present embodiment as illustrated in FIGS. 3 and 4, a flap piece 23 closer to the end than a folding base point 27 on a rear surface of the outer component 2 made of an aluminum alloy sheet is folded towards a rear surface of a main body 21 closer to the center than the folding base point 27 around the folding base point 27 such that an angle formed between the flap piece 23 and the main body 21 becomes an acute angle (pre-folding step).

The inner component 3 made of an aluminum alloy sheet is then disposed on the rear surface of the outer component 2 (inner component introducing step).

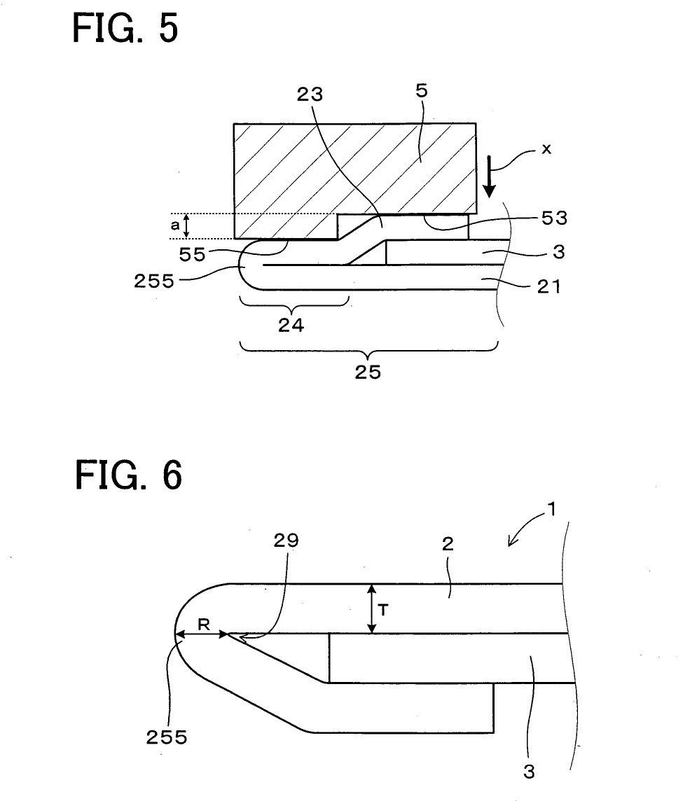

Next, as illustrated in FIG. 5, using a die 5 which has a first pressing surface 53 and a second pressing surface 55 that is more projecting than the first pressing surface 53 by the thickness of the inner component 3, pressing the flap piece 23 is performed while abutting the first pressing surface 53 and the second pressing surface 55 respectively against the flap piece 23 so that the inner component 3 is pinched and held between the main body 21 and the flap piece 23 through the first pressing surface 53 and the flap piece 23 and the main body 21 are closely contacted by the second pressing surface 55 to form an appressed portion 24 (hem region forming step).

The method of manufacturing the aluminum alloy sheet member of the present embodiment will be explained thereinafter in further details.

First, as illustrated in FIG. 1, a 6000-series aluminum alloy sheet, particularly a 6016-T4 material, having a thickness of 1.0 mm was pressed to prepare an outer component 2 including a convex portion 28 at a center thereof for use as a body sheet of a vehicle.

Another 6000-series aluminum alloy sheet same as that of the outer component 2 was pressed to prepare an inner component 3 including a plurality of convex and concave portions 38 for use as a body sheet of a vehicle. While a 6000-series aluminum alloy sheet was employed as the inner component in the present embodiment, it can alternatively be something different as long as it is an aluminum alloy sheet.

Next, two processing steps, namely the down-flange step and the pre-hem step were executed as the pre-folding step. More particularly, as the down-flange step as illustrated in FIG. 3, the flap piece 23 was folded in a substantially right-angular manner around the folding base point 27 towards the rear surface of the main body 21 (down-flange step) Next, as the pre-hem step as illustrated in FIG. 4, a bending process was performed in which the flap piece 23 was further folded around the folding base point 27 towards the rear surface of the main body 21 so that an angle formed between the flap piece 23 and the main body 21 becomes an acute angle (pre-hem step).

Thereafter, in the inner component introducing step as illustrated in FIG. 4 the inner component 3 that had been preliminarily press-molded for a body sheet of a vehicle was disposed on the rear surface of the outer component 2.

Then, in the hem region forming step as illustrated in FIG. 5, a die 5 having a first pressing surface 53 and a second pressing surface 55 that is more projecting by a thickness a than the first pressing surface 53 is prepared. The thickness a of the projecting portion of the second pressing surface 55 of the die 5 projecting from the first pressing surface 53 was equal to the thickness of the inner component 3, and the thickness was thus a=1.0 mm.

By using this die 5, the first pressing surface 53 and the second pressing surface 55 were respectively abutted against the flap piece 23 and pressed to press the flap piece 23 in a vertical direction (direction of arrow x in FIG. 5). In this manner, the main body 21, the inner component 3 and the flap piece 23 are laminated in a contacting manner by the first pressing surface 53 while the flap piece 23 and the main body 21 are laminated in a contacting manner by the second pressing surface 55 so as to form an appressed portion 24 at the hem end portion 255.

In this manner, the aluminum alloy sheet member 1 having the hem end portion 255 at the end of the hem region 25 whose outer bending radius R becomes R=11.0 mm with respect to the sheet thickness T=1.0 mm of the outer component was manufactured as illustrated in FIGS. 1 and 2.

As illustrated in FIGS. 1 and 2, the aluminum alloy sheet member 1 of the present embodiment comprises the appressed portion 255 at the hem end portion 255 formed by bending the outer component 2 in a contacting manner by 180°.

Accordingly, the hem region 25 becomes a sharp shape and a superior external appearance.

### Embodiment 2

The present embodiment is the embodiment in which the aluminum alloy sheet member is produced by varying the shape of the hem region of the aluminum alloy sheet member of the Embodiment 1.

As illustrated in FIG. 6, the hem region of the aluminum alloy sheet member of the present embodiment has no appressed portion at the hem end portion 255 but includes a space that is surrounded by the outer component 2 and the inner component 3, and the shape of the space is a substantially triangular shape having a corner 29 formed between the outer component 2 as one of the peaks thereof.

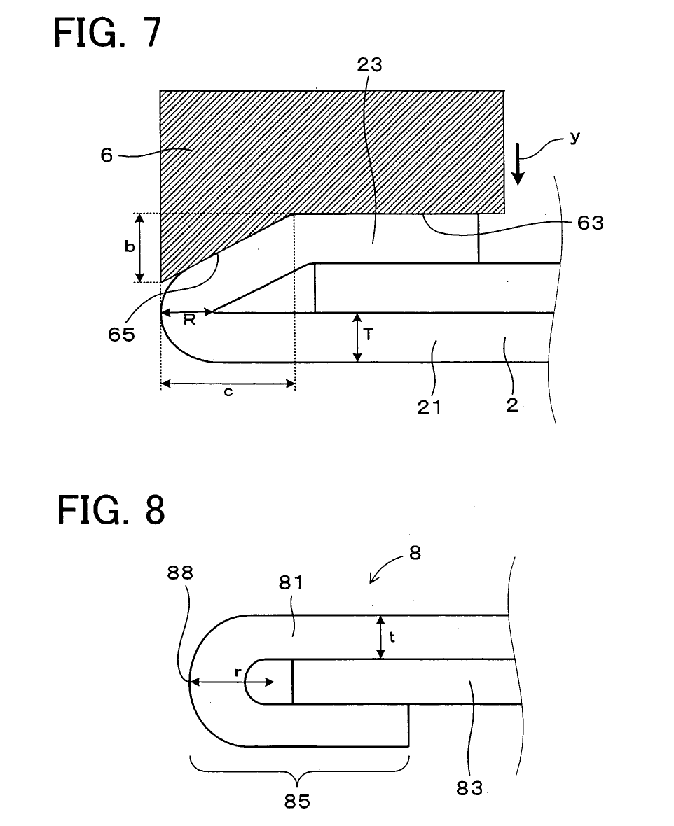

The method for manufacturing the aluminum alloy sheet member of the present embodiment will now be explained thereinafter by using FIG. 7.

First, an outer component 2 and an inner component 3 with a thickness of 1.0 mm and made of aluminum alloy sheet similar to those of the first embodiment were prepared. Then, by using the outer component 2 and the inner component 3 the pre-bending step and the inner component introducing step similar to those of the first embodiment was performed.

Then, as illustrated in FIG. 7, a die 6 having a first pressing surface 63 and a tapered pressing surface 65 projecting from the first pressing surface 63 in an oblique direction was prepared. The tapered surface 65 of the die 6 is arranged in that a height b from the first pressing surface 63 satisfies b=1.5 mm and a width c satisfies c=5 mm.

By using this die 6, the first pressing surface 63 and the tapered pressing surface 65 were respectively abutted against the flap piece 23 and pressed to press the flap piece 23 in a vertical direction (direction of arrow y in FIG. 6). In this manner, the main body 21, the inner component 3 and the flap piece 23 were laminated in a contacting manner by the first pressing surface 63 while the corner 29 formed between the outer component 2 was formed by the tapered pressing surface 65 in the space surrounded by the outer component 2 and the inner component 3.

In this manner, an aluminum alloy sheet member 1 including no appressed portion at the hem end portion 255 but including a space which is surrounded by the outer component 2 and the inner component 3 and whose shape is a substantially triangular shape having a corner 29 formed between the outer component 2 as one of the peaks thereof was manufactured as illustrated in FIG. 6.

In the present embodiment as illustrated in FIG. 6, the shape of the space surrounded by the outer component 2 and the inner component 3 is a substantially triangular shape which has the corner 29 formed by the outer component 2 as one of the peaks thereof.

Therefore, the hem region 25 becomes a sharp shape and a superior external appearance.

1. An aluminum alloy sheet member characterized by having a hem region and comprising an outer component which is made of an aluminum alloy sheet and an inner component which is made of an aluminum alloy sheet and attached to the outer component,
wherein the aluminum alloy sheet member has a hem end portion at an end of the hem region whose outer bending radius R satisfies R=1.0T-1.2T with respect to a sheet thickness T of the outer component.

2. The aluminum alloy sheet member as claimed in claim 1, characterized in that the aluminum alloy sheet member includes an appressed portion at the hem end portion formed by bending the outer component by 180° in a contacting manner.

3. The aluminum alloy sheet member as claimed in claim 1, characterized by including no appressed portion at the hem end portion but a space which is surrounded by the outer component and the inner component and whose shape is a substantially triangular shape having a corner formed between the outer component as one of the peaks thereof.

4. The aluminum alloy sheet member as claimed in claim 1, characterized in that a material of the outer component is a 6000-series aluminum alloy.
